(19) United States
(12) Patent Application Publication
(10) Pub. No.: US 2026/0228660 A1
(43) Pub. Date: Aug. 6, 2026

(54) VEHICLE-TO-GRID ENERGY TRANSFER SCHEDULING

(71) Applicant: Toyota Research Institute, Inc., Los Altos, CA (US)

(72) Inventors: Steven Bartholomew Joseph Torrisi, San Mateo, CA (US); Clement H. Wong, Englewood Cliffs, NJ (US); Amalie Emmy Trewartha, San Francisco, CA (US); Alexandre L.S. Filipowicz, Mountain View, CA (US)

(73) Assignees: Toyota Research Institute, Inc., Los Altos, CA (US); Toyota Jidosha Kabushiki Kaisha, Toyota-shi (JP)

(21) Appl. No.: 19/028,912

(22) Filed: Jan. 17, 2025

(51) Int. Cl. G06Q 10/0631; B60L 55/00; G06Q 30/0283; G06Q 50/06; G07C 5/04

(52) U.S. Cl. CPC G06Q 10/06313; G06Q 30/0283; G06Q 50/06; G07C 5/04; B60L 55/00

(57) ABSTRACT

Systems, methods, and other embodiments described herein relate to providing information to a user about vehicle-to-grid participation. In one embodiment, a method includes predicting future usage of a vehicle based on at least historical usage of the vehicle, determining a schedule for vehicle-to-grid participation based on at least the future usage of the vehicle, and outputting the schedule to an output system.

### TECHNICAL FIELD

The subject matter described herein relates, in general, to systems and methods for providing information to a user about vehicle-to-grid participation.

### BACKGROUND

‘Vehicle-to-Grid’ (V2G) systems allow an owner of a vehicle to be compensated for an energy transfer from a battery in the vehicle to an electric power grid, thus alleviating demand on the electric power grid during both peak and off-peak hours. However, the likelihood of an owner participating in V2G energy transfer depends largely on vehicle availability and/or vehicle usage patterns.

### SUMMARY

In one embodiment, a method for providing information to a user about vehicle-to-grid participation is disclosed. The method includes predicting future usage of a vehicle based on at least historical usage of the vehicle, determining a schedule for vehicle-to-grid participation based on at least the future usage of the vehicle, and outputting the schedule to an output system.

In another embodiment, a system for providing information to a user about vehicle-to-grid participation is disclosed. The system includes a processor and a memory in communication with the processor. The memory stores machine-readable instructions that, when executed by the one processor, cause the processor to predict future usage of a vehicle based on at least historical usage of the vehicle, determine a schedule for vehicle-to-grid participation based on at least the future usage of the vehicle, and output the schedule to an output system.

In another embodiment, a non-transitory computer-readable medium for providing information to a user about vehicle-to-grid participation is disclosed. The instructions include instructions to predict future usage of a vehicle based on at least historical usage of the vehicle, determine a schedule for vehicle-to-grid participation based on at least the future usage of the vehicle, and output the schedule to an output system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a vehicle incorporating a vehicle-to-grid participation system.

FIG. 2 illustrates a diagram of a vehicle-to-grid participation system in a cloud-based configuration.

FIG. 3 illustrates one embodiment of the vehicle-to-grid participation system.

FIG. 4 is a flowchart illustrating one embodiment of a method associated with providing information to a user about vehicle-to-grid participation.

### DETAILED DESCRIPTION

Systems, methods, and other embodiments associated with providing a schedule to a user for vehicle-to-grid (V2G) participation are disclosed. Vehicle-to-grid (V2G) systems engage in transferring energy from on-vehicle batteries to electric power grids. The owner or user of the vehicle may be financially compensated for transferring energy from one or more batteries in the vehicle to a power grid. Financial compensation incentivizes the owner or user of the vehicle to participate in energy transfer from the vehicle battery to the power grid and may further incentivize the owner or user of the vehicle to participate in V2G energy transfer at certain times such as peak hours or off-peak hours.

V2G energy transfer can be time-consuming and further, the vehicle involved in the V2G energy transfer may be required to remain stationary for the duration of the V2G energy transfer. Users are more likely to participate in V2G energy transfer if the V2G energy transfer process fits into the users' lifestyle and vehicle usage patterns. Users would also prefer to be informed of the impact of V2G energy transfer on the vehicle and more specifically, on the vehicle battery. Users would prefer to be informed of any financial compensation related to the V2G energy transfers and the times of the V2G energy transfers.

Utilities such as the power grids may also utilize the information, including the schedules, the impact on the vehicle battery, and/or the financial compensation to determine how to maximize benefits derived from V2G participation. As such, utility operators may learn from users' lifestyle, availability, and vehicle usage patterns and may then determine future expansions of V2G programs offered by the utilities. As an example, a utility may be focused on encouraging V2G energy transfer during peak hours so as to reduce evening peaks and may then start to implement a virtual powerplant-type energy storage system to store renewable energy if a large number of vehicles are available to be charged during times when renewable energy is available. In summary, a first portion of this system utilizes information about vehicle usage patterns and V2G program offered by utilities to maximize the benefits of V2G energy transfer for vehicle owners or users, and a second portion of the system utilizes the information about vehicle usage patterns to inform utilities such that the utilities may cater to the needs of vehicle owners and users, which may include expanding the services utilities provide as part of V2G programs.

Accordingly, in one embodiment, the disclosed approach is a system that informs a user on how V2G participation may be incorporated into the user's lifestyle and driving habits and then, further informs utilities such as power grids on how to cater to the needs of users and expand on the V2G programs. The system may be an application available on a mobile device, in a vehicle, and/or via a server. The system may include a user interface with which the user may interact with the system. The system may include an input system such as a touch pad or touch screen and an output system such as a display screen and/or an audio system, e.g., a speaker.

The system monitors historical vehicle usage relating to the times when the vehicle is travelling, when the vehicle is parked, locations where the vehicle is parked, and/or duration of the vehicle being parked. The system predicts future vehicle usage based on at least historical vehicle usage. The system may predict future vehicle usage based on environmental conditions such as weather, time of day, and/or temperature. The system may then predict potential times that the vehicle may participate in V2G energy transfer based on future vehicle usage. The system may request and receive real-time utility pricing structure from vehicles participating in V2G energy transfer and/or utilities such as power grids that are also participating in V2G energy transfer. The system may determine the impact, or more specifically, the negative impact of V2G energy transfer on the vehicle battery. The system may monitor the vehicle battery, communicate with a vehicle battery control system that controls the battery, and/or may utilize similar models of the battery to determine the impact on the vehicle battery. The system may then predict potential times that the vehicle may participate in V2G energy transfer so as to maximize financial compensation and minimize the negative impact on the vehicle battery such as battery degradation based on battery chemistry and/or battery pack configuration.

The system may output a schedule with the potential times to a user interface and/or an output system such as a display screen or an audio speaker. The system may receive user preferences via the user interface and may tailor the schedule to accommodate the user preferences. User preferences may include the days and/or times that the user would prefer to participate in the V2G energy transfer program. The user preferences may further include a minimum state of charge (SOC) and/or mileage for the vehicle battery as well as the minimum acceptable financial compensation. The schedule may include the potential times with the associated financial compensation and the associated projected vehicle battery degradation.

The system may also collect information relating to V2G participation for vehicles in the V2G energy transfer program and utilize the information to develop or expand V2G programs offered by utility companies.

The embodiments disclosed herein present various advantages over conventional technologies that generate vehicle design. First, the embodiments are able to determine schedules which include times and locations that a vehicle may participate in V2G energy transfer. Second, the embodiments may communicate the schedule to a user via a user interface and may receive user preferences via the user interface. Third, the embodiments may customize the schedule based on the user preferences. Fourth, the embodiments may generate and display the schedule based on the user preferences, financial compensation, and/or impact on the vehicle battery such as battery degradation.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

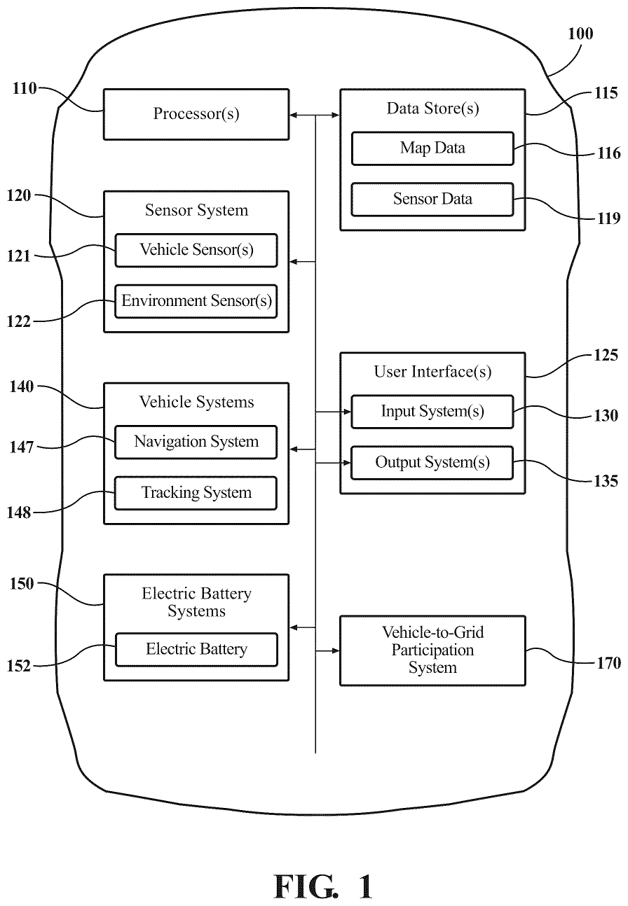

Referring to FIG. 1, a block diagram of a vehicle 100 incorporating a vehicle-to-grid (V2G) participation system 170 is illustrated. As used herein, “vehicle” means any form of motorized transport. In one or more implementations, the vehicle 100 can be an automobile. While arrangements will be described herein with respect to automobiles, it will be understood that embodiments are not limited to automobiles. The vehicle 100 can be any other type of vehicle that may be used on land, air, and/or sea. The vehicle 100 is an electric vehicle with at least one electric battery 152. The vehicle 100 is capable of transferring energy from the electric battery 152 to one or more power grids.

The vehicle 100 includes various elements. It will be understood that in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment.

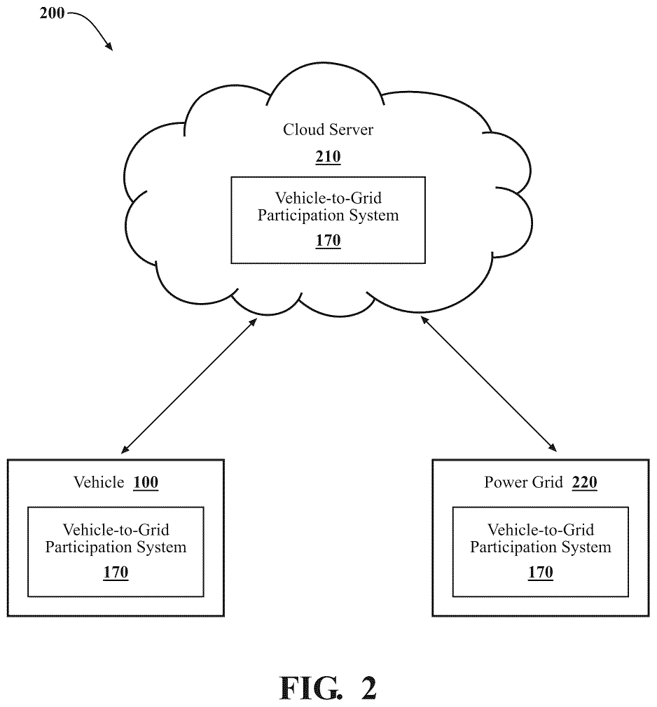

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 100 includes a V2G participation system 170 that is implemented to perform methods and other functions as disclosed herein relating to informing a user of how to integrate vehicle-to-grid participation into the usage of the vehicle 100. As will be discussed in greater detail subsequently, the V2G participation system 170, in various embodiments, may be implemented partially within the vehicle 100 and may further exchange communications with additional aspects of the V2G participation system 170 that are remote from the vehicle 100 in support of the disclosed functions. Thus, while FIG. 1 generally illustrates the V2G participation system 170 as being self-contained, in various embodiments, the V2G participation system 170 may be implemented within multiple separate devices some of which may be remote from the vehicle 100.

The vehicle 100 may include processor(s) 110, sensor system(s) 120, vehicle system(s) 140, user interface(s) 125, electric battery system(s) 150, data store(s) 115, and/or V2G participation system 170. The user interface 125 is capable of receiving user input and outputting information in a visual format and/or an audio format. The user interface 125 may include an input system 130 such as a keyboard, a touch screen, a microphone, and/or a touch pad. The user interface 125 may include an output system 135 such as a display screen and/or a speaker. The electric battery system(s) 150 includes the vehicle battery 152. The electric battery system(s) 150 may control and/or monitor the vehicle battery 152. The vehicle battery 152 may be an electric battery.

The V2G participation system 170 may be further implemented as a cloud-based system that functions within a cloud-computing environment 200 as illustrated in relation to FIG. 2. That is, for example, the V2G participation system 170 may acquire telematics data (i.e., sensor data 119) from vehicles and execute as a cloud-based resource that is comprised of devices (e.g., distributed servers) remote from the vehicle 100 to inform a user of how to integrate V2G participation into the usage of the vehicle 100. As another example, the V2G participation system 170 may be housed in a power grid 220. As another example, the V2G participation system 170 may be housed in a cloud server 210.

In one or more arrangements, a first portion of the V2G participation system 170 located in the vehicle 100 may perform a first part of the processing, a second portion of the V2G participation system 170 located in the power grid 220 may perform a second part of the processing, and a third portion of the V2G participation system 170 located in a cloud server 210 may perform the remaining portion of the processing to determine and provide to the user how to integrate V2G participation into the usage of the vehicle 100. It should be appreciated that apportionment of the processing between the vehicle 100, the power grid 220, and the cloud server 210 may vary according to different implementations.

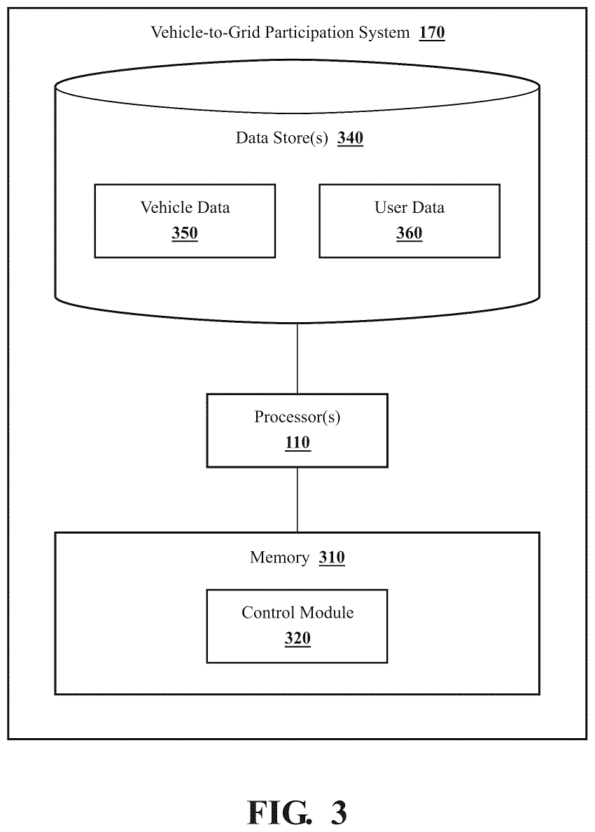

With reference to FIG. 3, one embodiment of the V2G participation system 170 of FIG. 1 is further illustrated. The V2G participation system 170 is shown as including a processor 110 from the vehicle 100 of FIG. 1. Accordingly, the processor 110 may be a part of the V2G participation system 170, the V2G participation system 170 may include a separate processor from the processor 110 of the vehicle 100, and/or the V2G participation system 170 may access the processor 110 through a data bus or another communication path. In further aspects, the processor 110 is a cloud-based resource that communicates with the V2G participation system 170 through a communication network.

In one embodiment, the V2G participation system 170 includes a memory 310 that stores a control module 320. The memory 310 is a random-access memory (RAM), read-only memory (ROM), a hard-disk drive, a flash memory, or other suitable memory for storing the control module 320. The control module 320 is, for example, computer-readable instructions within the physical memory 310 that when executed by the processor 110 cause the processor 110 to perform the various functions disclosed herein.

In one embodiment, the V2G participation system 170 includes a data store 340. The data store 340 is, in one embodiment, an electronic data structure (e.g., a database) stored in the memory 310 or another data store and that is configured with routines that can be executed by the processor 110 for analyzing stored data, providing stored data, organizing stored data, and so on. Thus, in one embodiment, the data store 340 stores data used by the control module 320 in executing various functions. In one embodiment, the data store 340 includes vehicle data 350, user data 360, and or other information that is used by the control module 320. The vehicle data 350 may contain information about the vehicle 100 such as the type of vehicle 100, the type of battery being utilized by the vehicle 100, the locations of the vehicle 100, and the times associated with the locations of the vehicle 100. The user data 260 may contain information about the user operating the vehicle 100 such as a user identifier, a user profile, a commute associated with the user that is based on the time of day and/or the day of the week, and/or user preference(s).

In one embodiment, the control module 320 includes instructions that function to control the processor 110 to predict future usage of a vehicle 100 based on at least historical usage of the vehicle 100. Historical usage of the vehicle 100 refers to how the vehicle 100 has been used in the past, such as in the past days, weeks, months, and/or years. Historical usage may include where the vehicle 100 has been located, time period(s) spent at the location, route(s) that the vehicle 100 has traveled, time spent on the route, and the time of travel. As an example, historical usage may include information about the vehicle 100 being parked at a home from 6 PM to 7 AM, then the vehicle 100 traveling along a highway from the home to work from 7 AM to 8 AM, the vehicle being parked at work from 8 AM to 5 PM, then the vehicle 100 traveling along the highway from the work to the home from 5 PM to 6 PM. The historical usage may include information about how the vehicle 100 is used in any suitable time period such as daily, weekly, monthly, and/or annually. As an example, the control module 320 may receive historical usage of the vehicle from the sensor system 120, a tracking system 148, and/or a navigation system 147. Future usage of the vehicle 100 refers to how the vehicle 100 may be used in the future. As such, future usage of the vehicle 100 may include locations where the vehicle 100 may park or be located, the time and time period that the vehicle may remain parked or at the location at a future time. In one or more arrangements, the control module 320 may utilize any suitable machine learning methods and/or artificial intelligence processes to determine the future usage of the vehicle 100 based on the historical usage of the vehicle 100. As an example, the control module 320 may identify patterns in the historical usage of the vehicle 100 and may apply the patterns to predict the future usage of the vehicle 100. In such an example, the historical usage of the vehicle 100 may include information indicating that the vehicle 100 is parked at home for two days every weekend, and so, the control module 320 may predict that for upcoming weekends, the vehicle 100 will be parked at home for two days during the weekend.

The control module 320 may generate a vehicle behavior model based on historical usage of a plurality of vehicles. The plurality of vehicles may include the vehicle 100. In such an arrangement, the control module 320 may receive historical usage of multiple vehicles and may train a vehicle behavior model on the historical usage of the vehicles. The control module 320 may utilize the vehicle behavior model to predict the future usage of one or more vehicles, which may include the vehicle 100. The future usage may include driving patterns, parking patterns, location patterns, charging patterns, and/or V2G energy transfer patterns.

In one embodiment, the control module 320 includes instructions that function to control the processor 110 to generate a grid system model based on historical behavior of a plurality of power grids. The control module may train the grid system model on grid data that includes various energy demand and response scenarios based on at least consumer energy demands, energy sources such as natural gas and renewable energy, which may include solar energy, wind energy, hydro energy, tidal energy, geothermal energy, and/or biomass energy, and energy costs.

In one embodiment, the control module 320 includes instructions that function to control the processor 110 to generate an optimization model that determines the feasibility of various vehicle-to-grid program implementations. As an example, a program may be aimed at reducing energy consumption at peak hours in a day, week, and/or year and selecting alternative time periods during the day, week, and/or year for incentivizing vehicle-to-grid participation. As another example, a program may determine the feasibility of using connected vehicles as a “virtual power plant” that stores solar energy during the day and discharges the energy at night. The control module 320 may train the optimization model using vehicle data as well as grid data. The control module 320 may utilize any suitable method such as machine learning methods and/or artificial intelligence processes to generate the optimization model. The control module 320 may then feed one or more vehicle-to-grid program implementations to the optimization model, which then outputs the associated feasibility for each of the one or more vehicle-to-grid program implementations.

In one embodiment, the control module 320 includes instructions that function to control the processor(s) 110 to determine an outcome of a vehicle-to-grid scenario based on the vehicle-to-grid scenario, the vehicle behavior model, and/or the grid system model. As such and as an example, the control module 320 may predict the level of user involvement, the types of energy being transferred, the times of day that vehicle-to-grid participation is occurring or not occurring, and/or the level of participation. The control module 320 may apply the vehicle-to-grid scenario to the vehicle behavior model and the grid system model as well as any other suitable models or methods such as machine learning and/or artificial intelligence processes. As an example, the vehicle-to-grid scenario may include the vehicle-to-grid participation of two vehicles in the morning and eighty vehicles in the evening and the control module 320 may determine based on the models that it may be beneficial to incentivize users to participate in V2G energy transfer in the morning. As such, the control module 320 may determine and increase financial compensation for vehicle-to-grid participation in the morning.

In one embodiment, the control module 320 includes instructions that function to control the processor 110 to determine levels of vehicle-to-grid participation at the plurality of grids at different periods of time. The control module 320 may receive sensor data 119 from vehicle sensor system(s) 120, power grid sensors, and any other suitable environmental sensors. Additionally and/or alternatively, the control module 320 may request and receive data records from data storage units in vehicle(s) 100, power grid(s) 220, and/or cloud server(s) 210. The data records may include information about vehicles 100 and/or power grids 220 that have participated in vehicle-to-grid energy transfer, locations, duration of the V2G energy transfer, the dates, and the times of day of the V2G energy transfer. The control module 320 may determine the levels of vehicle-to-grid participation based on this received information.

In one embodiment, the control module 320 includes instructions that function to control the processor 110 to determine incentives for at least one of the plurality of vehicles based on the levels of vehicle-to-grid participation. The control module 320 may utilize any suitable data to determine incentives, particularly effective incentives that would encourage users to participate in the energy transfer program at various times. The control module 320 may receive data based on research on what and how users respond to incentives. The control module 320 may utilize any suitable process or algorithm such as polling users electronically, to determine, as an example, the amount of financial compensation that would encourage users to participate in the energy transfer program at the various times.

In one embodiment, the control module 320 includes instructions that function to control the processor 110 to determine a schedule for vehicle-to-grid participation based on at least the future usage of the vehicle 100. The control module 320 may determine a suitable location, a suitable time, and a suitable time period for the vehicle 100 to participate in transferring energy from the vehicle 100, or more specifically, the electric battery 152 of the vehicle 100, to a power grid 220. The control module 320 may determine the suitable location(s), time(s), and time periods based on the predicted future usage of the vehicle 100. The control module 320 may identify time periods in the predicted future usage of the vehicle 100 when the vehicle 100 will be parked and not being driven by the user. The control module 320 may also determine a location of the vehicle 100 when the vehicle 100 is parked based on the predicted future usage of the vehicle 100, and then, may identify power grids 220 proximate to the location of the vehicle 100. The control module 320 may then populate the schedule such the schedule may include at least the location of the power grid(s) 220, duration of the V2G energy transfer, the time(s) that the V2G energy transfer may commence (i.e., a V2G energy transfer start time), and the time(s) that the V2G energy transfer may end (i.e., a V2G energy transfer end time). The schedule may further include the amount of energy that will be transferred in the duration of the V2G energy transfer.

In one embodiment, the control module 320 includes instructions that function to control the processor 110 to determine financial compensation for the vehicle 100 based on at least the schedule for vehicle-to-grid participation and vehicle-to-grid participation pricing structure. The vehicle-to-grid participation pricing structure may include information such as compensation rates based on the receiving power grid 220, the time of day, the day of the week, low-energy demand periods, high energy demand periods, weather, environmental issues, the number of power grids 220 online and available to provide or receive energy, and/or the amount of energy available to consumers in a selected time period. The vehicle-to-grid participation pricing structure may be stored in a database in any suitable location such as in a server. The control module 320 may determine the financial compensation the user will receive based on the schedule for vehicle-to-grid participation and vehicle-to-grid participation pricing structure. More specifically, the control module 320 may select power grids 220, allotted time(s), V2G energy transfer start time(s), and V2G energy transfer end time(s) in the database that match the power grids 220, allotted time(s), V2G energy transfer start time(s), and V2G energy transfer end time(s) in the schedule, respectively. The control module 320 may then determine the financial compensation associated with the selected power grids 220, allotted time(s), V2G energy transfer start time(s), and V2G energy transfer end time(s) in the database. As an example, the control module 320 may update the schedule to include the financial compensation associated with one or more combinations of the power grids 220, allotted time(s), V2G energy transfer start time(s), and V2G energy transfer end time(s) in the database.

In one embodiment, the control module 320 includes instructions that function to control the processor 110 to determine a second schedule for maximum financial compensation for vehicle-to-grid participation based on at least the schedule for vehicle-to-grid participation and vehicle-to-grid participation pricing structure. In one or more arrangements, the control module 320 may select the combinations of the power grids 220, allotted time(s), V2G energy transfer start time(s), and V2G energy transfer end time(s) in the database that may provide the user with the maximum financial compensation. In such a case and as an example, the control module 320 may select the combination(s) of the power grids 220, allotted time(s), V2G energy transfer start time(s), and V2G energy transfer end time(s) in the database that would provide the highest financial compensation to the user. As another example, the control module 320 may select the combinations of the power grids 220, allotted time(s), V2G energy transfer start time(s), and V2G energy transfer end time(s) in the database that would provide a range of the highest financial compensations to the user. In such an example, the range of the top highest financial compensations may include the highest financial compensation through to the fifth highest financial compensation.

In one embodiment, the control module 320 includes instructions that function to control the processor 110 to determine an impact on a battery 152 of the vehicle 100 for vehicle-to-grid participation based on at least characteristics of the battery 152. The control module 320 may request and receive information about the battery 152 from the electric battery system(s) 150 in the vehicle 100. The control module 320 may receive information about the battery 152 such as a brand name, a model number, the amount of energy charge currently in battery 152, capacity of the battery 152, the condition of the battery 152, and/or any other relevant information or history relating to the battery 152. The control module 320 may then determine the impact of energy transfer on the battery 152. The impact on the battery 152, or more specifically, the negative impact on the battery 152 may include the battery 152 having a reduced charge, irreversible damage to the battery 152 that may significantly affect battery life, the amount of heat generated during the energy transfer which may lead to energy loss and/or damage, and/or acceleration of the degradation of components within the battery 152. The control module 320 may also utilize information such as a depth of discharge, an energy transfer rate, and/or a chemical reaction occurring between the components in the battery 152 to determine the impact on the battery 152 when the vehicle 100 is participating in vehicle-to-grid energy transfer. The control module 320 may determine the impact on the battery 152 based on at least the characteristics of the battery 152, environmental conditions such as temperature, weather, humidity levels, and/or energy transfer process such as energy transfer rate and depth of discharge. The control module 320 may utilize any suitable algorithm, modeling methods, machine learning methods, and/or artificial intelligence processes to determine the impact on the battery 152 for the battery 152 transferring energy to a power grid 220.

In one embodiment, the control module 320 includes instructions that function to control the processor 110 to determine a third schedule for minimum battery impact for vehicle-to-grid participation based on at least the schedule for vehicle-to-grid participation and characteristics of the battery 152. In other words, the control module 320 may determine the third schedule for minimum impact on the battery 152 based on at least the schedule for vehicle-to-grid participation and characteristics of the battery 152. In one or more arrangements, the control module 320 may rank the combinations of locations of the power grids 220, the duration of the energy transfer, the start time, and end times based on which combination has the least negative impact on the battery 152. The control module 320 may prioritize certain types of impact over other types of impact. As an example, the control module 320 may prioritize the likelihood and/or the amount of irreversible damage to the battery 152 that may significantly affect battery life over the battery 152 having a reduced charge. The control module 320 may then rank the combinations from the combinations with the least likelihood and/or the least amount of irreversible damage to the combinations with the highest likelihood and/or the highest amount of irreversible damage. The control module 320 may receive input from the user about what type of impact to prioritize. In response to the user input, the control module 320 may rank the combinations based on the selected type of impact.

In one embodiment, the control module 320 includes instructions that function to control the processor 110 to output the schedule(s) to a user interface 125, or more specifically, an output system 135. The output system 135 may be a display system such as a display screen and/or an audio system such as a speaker. As an example, the display system may be located in the vehicle 100 and/or a mobile device. As another example, the audio system may be located in the vehicle 100 and/or the mobile device. The output system 135 may be at any other suitable location such as at the power grid 220 or in a cloud server 210. The output system 135 may be a display system visible to the user and/or an audio system audible to the user. Additionally and/or alternatively, the control module 320 may output the schedule(s) to a user interface 125 capable of receiving information from a user via an input system 130 and outputting information via an output system 135, such as a display and/or a speaker.

The control module 320 may receive information from the user via the user interface 125. As an example, the control module 320 may receive information about a level of vehicle-to-grid participation by the user. In such an example, the level of participation may include parameters for number of days in a week that a user would like to participate, a minimum state of charge and/or mileage to be maintained by the vehicle battery 152, and/or the number of times the user would like to engage in the vehicle-to-grid participation. Another example, the user may input into and/or receive from the user interface 125 information relating to models of battery degradation and/or financial compensation for vehicle-to-grid participation. As such, the control module 320 may receive information about the preferences of the user. The control module 320 may also receive the prioritization levels of the user for various objectives. As an example, an objective may be to prioritize low battery state of charge during storage which may include discharge during off-peak hours over battery drain only during peak hours so as to maximize financial compensation. The control module 320 may output projected battery degradation and/or project financial compensation for various strategies and constraints.

The format of the schedules (such as the schedules mentioned above, e.g., the schedule, the second schedule, and the third schedule) may be such that various combinations are shown on the screen and/or audibly output through the speaker. As an example, the display may have different tabs showing the schedule based on the future usage of the vehicle 100, the second schedule based on the future usage of the vehicle 100 and financial compensation, the third schedule based on the future usage of the vehicle 100, financial compensation, and the impact on the battery 152 of the vehicle 100.

The control module 320 may filter out certain combinations based on the preferences of the user. As an example, the control module 320 may receive preferences from the user, indicating the minimum battery state of charge or mileage to be maintained within the battery 152 and/or the times that the user would like to participate in vehicle-to-grid energy transfer. The control module 320 may then output the combinations where the combinations that match the preferences of the user are left in and are visible (or audible) to the user, and the combinations that do not match the preferences of the user are filtered out and are not visible or audible to the user.

The control module 320 may output the schedules in any suitable manner such as using the output system 135. As an example, the control module 320 may output the schedules in a visual and/or audible manner. In such an example, the control module 320 may output the schedules to a display visible to the user, such as an in-vehicle display and/or a mobile device display. The control module 320 may output the energy information verbally through a speaker. As another example, the control module 320 may transmit the schedules to a server and/or a third party.

The control module 320 may determine a notification criteria and output the schedules according to the notification criteria. The notification criteria may be, in one example, a user defined preference indicating when and what information relating to the schedules is to be provided to the user. As an example of the notification criteria, the control module 320 may receive user input indicating when the user prefers to be updated about the schedules. The user input may indicate that the user prefers to be updated, as an example, at the end of each trip in a day, once a day at a specific time, once a week, when the user requests an update, or when the vehicle 100 is proximate to a location such as a power grid 220, the user's home or office.

The control module 320 may be automatically set using a rule-based system such as providing updated outputs once a day, once a week, at the end of the day, upon request from the user, upon arriving at a specific location. Additionally and/or alternatively, the control module 320 may utilize any suitable machine learning algorithm to determine an acceptable rule or frequency for updating the user. The control module 320 may consider historical information such as how often the user has interacted with the V2G participation system 170. The control module 320 may consider popular notification rates based on popularity amongst users in general. As previously mentioned, the control module 320 may output the schedules to the user based on the notification criteria.

In one embodiment, the control module 320 includes instructions that function to control the processor 110 to operate a vehicle system 140 and/or the vehicle 100 in response to a selected combination. As an example, the user may select a combination from the schedule(s) and in response to the selected combination, the control module 320 may activate the vehicle 100 to travel to the power grid 220 in the selected combination. As another example, the user may set up criteria with which the control module 320 may then select a combination and activate a vehicle system 140 such as the navigation system 147 to generate a route to the power grid 220 based on the combination. As another example, the control module 320 may select a combination and activate an autonomous control system to control the vehicle 100 and travel to the location of the power grid 220. As another example, the control module 320 may activate a vehicle system such as the electric battery system(s) 150, such that the electric battery system(s) 150 may run tests and any other suitable steps in preparation for an upcoming energy transfer involving the battery 152.

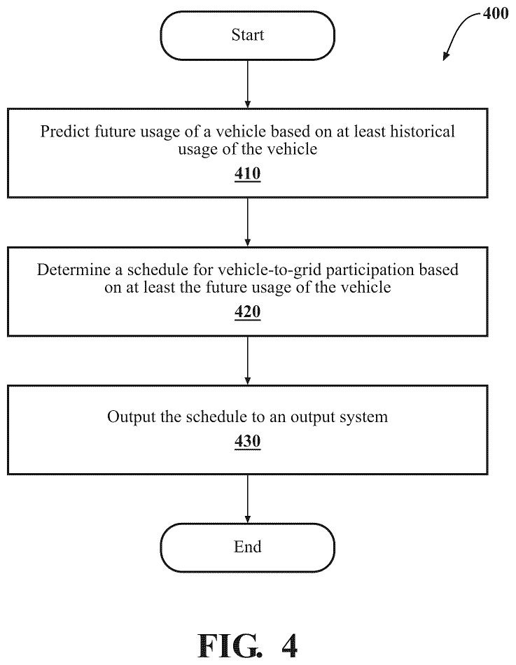

FIG. 4 illustrates a method 400 for informing a user on how V2G participation may be incorporated into the user's lifestyle and driving habits and then, further informs utilities such as power grids 220 on how to cater to the needs of users and expand on the V2G programs. The method 400 will be described from the viewpoint of the vehicle 100 of FIG. 1, the cloud-computing environment 200 of FIG. 2, and/or the V2G participation system 170 of FIG. 3. However, the method 400 may be adapted to be executed in any one of several different situations and not necessarily by the vehicle 100 of FIG. 1, the cloud-computing environment 200 of FIG. 2, and/or the V2G participation system 170 of FIG. 3.

At step 410, the control module 320 may cause the processor(s) 110 to predict future usage of a vehicle 100 based on at least historical usage of the vehicle 100. As previously mentioned, the control module 320 may employ any suitable techniques to predict future usage of the vehicle.

At step 420, the control module 320 may cause the processor(s) 110 to determine a schedule for vehicle-to-grid participation based on at least the future usage of the vehicle 100, as discussed above. The schedule may include one or more combinations of power grid locations, start times, end times, duration of energy transfer, financial compensation, and impact on vehicle battery 152. As such, the control module 320 may utilize additional information to determine the schedule for the vehicle-to-grid participation. As an example, the additional information may include vehicle battery design, vehicle environmental condition(s), historical driving behavior of user, utility pricing structure for vehicles participating in energy transfer from the vehicle to the power grid(s), and/or user preferences such as a baseline or target range for mileage or state of charge for the vehicle battery. The additional information may also include proposed protocols or goals such as increasing vehicle-to-grid participation at off-peak hours based on providing financial compensation to the users and/or minimizing battery degradation by limiting the duration of the energy transfer.

At step 430, the control module 320 may cause the processor(s) 110 to output the schedule to a user interface 125 such as an output system 135. The output system 135 may be a display system, an audio system, and/or any suitable user interface.

FIG. 1 will now be discussed in full detail as an example environment within which the system and methods disclosed herein may operate. The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 215 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more environment sensors 122 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor(s) 110 to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles, temperature, road conditions).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, a tracking system 148, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which the vehicle 100 is located or one or more portions thereof. The one or more environment sensors 122 can be configured to detect, measure, quantify and/or sense other objects in the external environment of the vehicle 100, such as, for example, lane markers, signs, traffic lights, traffic signs, lane lines, crosswalks, curbs proximate the vehicle 100, off-road objects, electronic roadside devices, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a user (e.g., a driver or a passenger). The vehicle 100 can include an output system 135. An “output system” includes any device, component, or arrangement or groups thereof that enable information/data to be presented to a user (e.g., a person, a vehicle passenger, etc.). The vehicle 100 can include a user interface 125 that a user may interact with. The user interface 125 may include the input system 130 and the output system 135. Alternatively, the user interface 125 may be a separate component in the vehicle.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system, a braking system, a steering system, throttle system, a transmission system, a navigation system 147, and/or a tracking system 148. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system. The tracking system 148 can include one or more devices, applications, and/or combinations thereof, now or later developed, configured to determine the geographic location of the vehicle 100 and/or the positioning of the vehicle 100 relative to surrounding infrastructure and landmarks. The tracking system 148 can include one or more mapping applications to determine the positioning of the vehicle 100. The tracking system 148 can include a global positioning system, a local positioning system, or a geolocation system.

The processor(s) 110 and/or the V2G participation system 170 can be operatively connected to communicate with the various vehicle systems 140, the electric battery systems 150, and/or individual components thereof. For example, returning to FIG. 1, the processor(s) 110 and/or the V2G participation system 170 can be in communication to send and/or receive information from the various vehicle systems 140 to determine locations such as the origin and the destination of the journey, the speed of travel, and/or proximate charging locations. As another example, the processor(s) 110 and/or the V2G participation system 170 can be in communication to control the various vehicle systems 140 and/or the electric battery systems 150 such as determine a route of travel, control or drive the vehicle 100, track the location of the vehicle 100, and/or prepare the electric battery 152 for V2G energy transfer.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4 but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A method comprising:
predicting future usage of a vehicle based on at least historical usage of the vehicle;
determining a schedule for vehicle-to-grid participation based on at least the future usage of the vehicle; and
operating a vehicle system in response to the schedule, including controlling an electric battery of the vehicle to facilitate vehicle-to-grid energy transfer between the electric battery and a grid.

2. The method of claim 1, wherein the output system is at least one of:
a display system; and
an audio system.

3. The method of claim 1, further comprising:
determining financial compensation for the vehicle based on at least the schedule for vehicle-to-grid participation and vehicle-to-grid participation pricing structure.

4. The method of claim 1, further comprising:
determining a second schedule for maximum financial compensation for vehicle-to-grid participation based on at least the schedule for vehicle-to-grid participation and vehicle-to-grid participation pricing structure.

5. The method of claim 1, further comprising:
determining an impact on a battery of the vehicle for vehicle-to-grid participation based on at least a characteristic of the battery.

6. The method of claim 1, further comprising:
determining a third schedule for minimum impact on a battery of the vehicle for vehicle-to-grid participation based on at least the schedule for vehicle-to-grid participation and a characteristic of the battery.

7. The method of claim 1, further comprising:
generating a vehicle behavior model based on historical usage of a plurality of vehicles, the plurality of vehicles including the vehicle;
generating a grid system model based on historical behavior of a plurality of grids;
determining levels of vehicle-to-grid participation at the plurality of grids at different periods of time; and
determining incentives for at least one of the plurality of vehicles based on the levels of vehicle-to-grid participation.

8. A system comprising:
a processor; and
a memory storing machine-readable instructions that, when executed by the processor, cause the processor to:
predict future usage of a vehicle based on at least historical usage of the vehicle;
determine a schedule for vehicle-to-grid participation based on at least the future usage of the vehicle; and
operate a vehicle system in response to the schedule, including control an electric battery of the vehicle to facilitate vehicle-to-grid energy transfer between the electric battery and a grid.

9. The system of claim 8, wherein the output system is at least one of:
a display system; and
an audio system.

10. The system of claim 8, wherein the machine-readable instructions further include instructions that when executed by the processor cause the processor to:
determine financial compensation for the vehicle based on at least the schedule for vehicle-to-grid participation and vehicle-to-grid participation pricing structure.

11. The system of claim 8, wherein the machine-readable instructions further include instructions that when executed by the processor cause the processor to:
determine a second schedule for maximum financial compensation for vehicle-to-grid participation based on at least the schedule for vehicle-to-grid participation and vehicle-to-grid participation pricing structure.

12. The system of claim 8, wherein the machine-readable instructions further include instructions that when executed by the processor cause the processor to:
determine an impact on a battery of the vehicle for vehicle-to-grid participation based on at least a characteristic of the battery.

13. The system of claim 8, wherein the machine-readable instructions further include instructions that when executed by the processor cause the processor to:
determine a third schedule for minimum impact on a battery of the vehicle for vehicle-to-grid participation based on at least the schedule for vehicle-to-grid participation and a characteristic of the battery.

14. The system of claim 8 wherein the machine-readable instructions further include instructions that when executed by the processor cause the processor to:
generate a vehicle behavior model based on historical usage of a plurality of vehicles, the plurality of vehicles including the vehicle;
generate a grid system model based on historical behavior of a plurality of grids;
determine levels of vehicle-to-grid participation at the plurality of grids at different periods of time; and
determine incentives for at least one of the plurality of vehicles based on the levels of vehicle-to-grid participation.

15. A non-transitory computer-readable medium including instructions that, when executed by a processor, cause the processor to:
predict future usage of a vehicle based on at least historical usage of the vehicle;
determine a schedule for vehicle-to-grid participation based on at least the future usage of the vehicle; and
operate a vehicle system in response to the schedule, including control an electric battery of the vehicle to facilitate vehicle-to-grid energy transfer between the electric battery and a grid.

16. The non-transitory computer-readable medium of claim 15, wherein the output system is at least one of:
a display system; and
an audio system.

17. The non-transitory computer-readable medium of claim 15, wherein the instructions further include instructions that when executed by the processor cause the processor to:
determine financial compensation for the vehicle based on at least the schedule for vehicle-to-grid participation and vehicle-to-grid participation pricing structure.

18. The non-transitory computer-readable medium of claim 15, wherein the instructions further include instructions that when executed by the processor cause the processor to:
determine a second schedule for maximum financial compensation for vehicle-to-grid participation based on at least the schedule for vehicle-to-grid participation and vehicle-to-grid participation pricing structure.

19. The non-transitory computer-readable medium of claim 15, wherein the instructions further include instructions that when executed by the processor cause the processor to:
determine an impact on a battery of the vehicle for vehicle-to-grid participation based on at least a characteristic of the battery.

20. The non-transitory computer-readable medium of claim 15, wherein the instructions further include instructions that when executed by the processor cause the processor to:
determine a third schedule for minimum impact on a battery for vehicle-to-grid participation based on at least the schedule for vehicle-to-grid participation and a characteristic of the battery.
